(19) United States
(12) Patent Application Publication
(10) Pub. No.: US 2025/0028040 A1
(43) Pub. Date: Jan. 23, 2025

(54) POSITION ESTIMATION SYSTEM AND POSITION ESTIMATION METHOD

(71) Applicant: DENSO CORPORATION, Kariya-city (JP)

(72) Inventors: Ryosuke KANBAYASHI, Kariya-city (JP); Kazuhiro Nakashima, Kariya-city (JP); Chiharu Yamano, Kariya-city (JP); Hiromitsu Ohba, Kariya-city (JP)

(21) Appl. No.: 18/908,291

(22) Filed: Oct. 7, 2024

Related U.S. Application Data
(63) Continuation of application No. PCT/JP2023/014882, filed on Apr. 12, 2023.

(30) Foreign Application Priority Data
Apr. 22, 2022 (JP) 2022-070809

(51) Int. Cl. G01S 13/76; B60R 25/24; B60R 25/31

(52) U.S. Cl. CPC G01S 13/765; B60R 25/245; B60R 25/31

(57) ABSTRACT

A position estimation system determines the location of a mobile device relative to a vehicle by wirelessly communicating with the device. The system includes multiple communicators installed at different positions in the vehicle, and a communication controller that manages these communicators. The communication controller collects signal reception strength and a time-of-flight related value from the mobile device. This time-of-flight value indicates the travel time of radio waves between the communicators and the mobile device. A position estimation unit corrects this time-of-flight value using a correction function based on teaching data that includes device positions, signal strengths, and time-of-flight values. The corrected time-of-flight value is used to estimate the mobile device's position. The data volume of the correction function is smaller than that of the teaching data.

### CROSS REFERENCE TO RELATED APPLICATIONS

The present application is a continuation application of International Patent Application No. PCT/JP2023/014882 filed on Apr. 12, 2023, which designated the U.S. and claims the benefit of priority from Japanese Patent Application No. 2022-070809 filed on Apr. 22, 2022. The entire disclosures of all of the above applications are incorporated herein by reference.

### TECHNICAL FIELD

The present disclosure relates to a position estimation system and a position estimation method for estimating a relative position of a mobile device to a vehicle.

### BACKGROUND ART

Conventional position estimation devices estimate a position of an electronic key relative to a vehicle. The position estimation devices estimate the position using received signal strength of a vehicle signal received by the electronic key.

### SUMMARY

According to at least one embodiment, a position estimation system estimates a position of a mobile device relative to a vehicle. The position estimation system communicates wirelessly with the mobile device carried by a user. The position estimation system includes communicators and a communication controller. The communicators wirelessly communicate with the mobile device and are installed at different positions in the vehicle. The communication controller manages the operation of the communicators. Additionally, the system has a position estimation unit that estimates the position of the mobile device. The communication controller acquires the reception strength of signals from the mobile device at each communicator. It also acquires a time-of-flight related value, which is a parameter different from the reception strength. This value indicates, directly or indirectly, the time of flight of radio waves sent from the communicators to the mobile device. The position estimation unit corrects the time-of-flight related value using a correction function. This function acquires a corrected time-of-flight related value by inputting the reception strength and the time-of-flight related value acquired by the communication controller. The position estimation unit then estimates the position of the mobile device using the corrected time-of-flight related value. The correction function is determined using teaching data. This data includes positions of the mobile device, the reception strength, and the time-of-flight related values at these positions. The data volume of the correction function is smaller than the data volume of the teaching data.

### BRIEF DESCRIPTION OF DRAWINGS

The details of one or more embodiments are set forth in the accompanying drawings and the description below. Other features and advantages will be apparent from the description and drawings, and from the claims.

FIG. 1 is a block diagram illustrating a configuration of an electronic key system.

FIG. 2 is a diagram illustrating an example of anchor placement.

FIG. 3 is a flowchart illustrating a position estimation method.

FIG. 4 is a diagram explaining of the position estimation method.

FIG. 5 a diagram explaining of a neural network.

### DETAILED DESCRIPTION

To begin with, examples of relevant techniques will be described.

Conventionally, there is an electronic key system that permits or executes a predetermined process for a vehicle, such as unlocking the vehicle or starting an engine of the vehicle, based on wireless communication between an in-vehicle device and an electronic key. This electronic key system permits or executes a process depending on a position of the electronic key in relation to the vehicle. Therefore, an estimation of the position of the electronic key is necessary.

One method for estimating the position of the electronic key relative to the vehicle is to use received signal strength of a vehicle signal received by the electronic key. More specifically, the position of the electronic key is estimated based on a combination of received signal strength when the electronic key receives a vehicle signal transmitted from one onboard antenna and received signal strength when the electronic key receives a vehicle signal transmitted from another onboard antenna. This is because the received signal strength correlates with distance since the received signal strength weakens as the distance from a source increases.

An electronic key system according to a comparative example uses the relationship between receiving sensitivity of the electronic key and the received signal strength to estimate the position of the electronic key with compensation for the received signal strength, taking into account individual differences in the receiving sensitivity of the electronic key.

Another method for estimating a position of an electronic key is a ranging method that uses a time of flight (ToF) of a wireless signal.

In the distance measurement method using ToF to estimate the position of the electronic key, if there is an obstacle such as a car body or human body between an antenna mounted on the vehicle and the electronic key, the measurement distance will be extended due to diffraction of radio waves and detection of only reflected waves without detection of direct waves and due to shadows of obstacles, resulting in a large error in position estimation.

When estimating the position of the electronic key, accuracy of position estimation can be improved by using previously obtained actual measurement data and comparing the actual data with the measured data. The more measurement points in the actual data, the more accurate the position estimation, but the larger the amount of data required.

In contrast to the comparative example, according to a position estimation system and a position estimation method of the present disclosure, a position of a mobile device can be estimated more accurately based on signals emitted from the mobile device with a small amount of data.

According to one aspect of the present disclosure, a position estimation system estimates a position of a mobile device relative to a vehicle. The position estimation system communicates wirelessly with the mobile device carried by a user. The position estimation system includes communicators and a communication controller. The communicators wirelessly communicate with the mobile device and are installed at different positions in the vehicle. The communication controller manages the operation of the communicators. Additionally, the system has a position estimation unit that estimates the position of the mobile device. The communication controller acquires the reception strength of signals from the mobile device at each communicator. It also acquires a time-of-flight related value, which is a parameter different from the reception strength. This value indicates, directly or indirectly, the time of flight of radio waves sent from the communicators to the mobile device. The position estimation unit corrects the time-of-flight related value using a correction function. This function acquires a corrected time-of-flight related value by inputting the reception strength and the time-of-flight related value acquired by the communication controller. The position estimation unit then estimates the position of the mobile device using the corrected time-of-flight related value. The correction function is determined using teaching data. This data includes positions of the mobile device, the reception strength, and the time-of-flight related values at these positions. The data volume of the correction function is smaller than the data volume of the teaching data.

According to another aspect of the present disclosure, a position estimation method is performed by at least one processor to estimate the position of a mobile device carried by a user. The method involves acquiring the reception strength of signals of the mobile device at communicators that wirelessly communicate with the device and are installed at different positions in a vehicle. Additionally, the method includes acquiring a time-of-flight related value, which is a parameter different from the reception strength and directly or indirectly indicates the time of flight of radio waves sent from the communicators to the mobile device. The time-of-flight related value is corrected using a correction function. This correction function acquires a corrected time-of-flight related value by inputting the reception strength and the time-of-flight related value acquired in the previous steps. The position of the mobile device is then estimated using this corrected time-of-flight related value. The correction function is determined using teaching data. This teaching data includes positions of the mobile device, the reception strength, and the time-of-flight related values at those positions. The data volume of the correction function is smaller than the data volume of the teaching data.

This position estimation system and position determination method, the reception strength and the time-of-flight related values at the communicators are used to estimate the position of the mobile device. The reception strength and the time-of-flight related values are different parameters from each other and may have different factors that cause errors. Therefore, an estimated position of the mobile device using only the reception strength may not match an estimated position of the mobile device using only the time-of-flight related values. Therefore, the time-of-flight related values are corrected using the correction function that is for acquiring corrected time-of-flight related values by inputting the acquired reception strength and the time-of-flight related values.

The correction function is a function determined using the teaching data that includes positions of the mobile device and the reception strength and the time-of-flight related values at the positions of the mobile device. The correction function is then generated so that the amount of data is smaller than the teaching data. As a result, an amount of data can be reduced compared to storing all of the teaching data and correcting using the teaching data. Since the time-of-flight related values are corrected by the correction function using two parameters, correction accuracy can be improved compared to a configuration in which only one parameter is used for correction. As a result, the position of the mobile device can be more accurately estimated using the corrected time-of-flight related values.

### First Embodiment

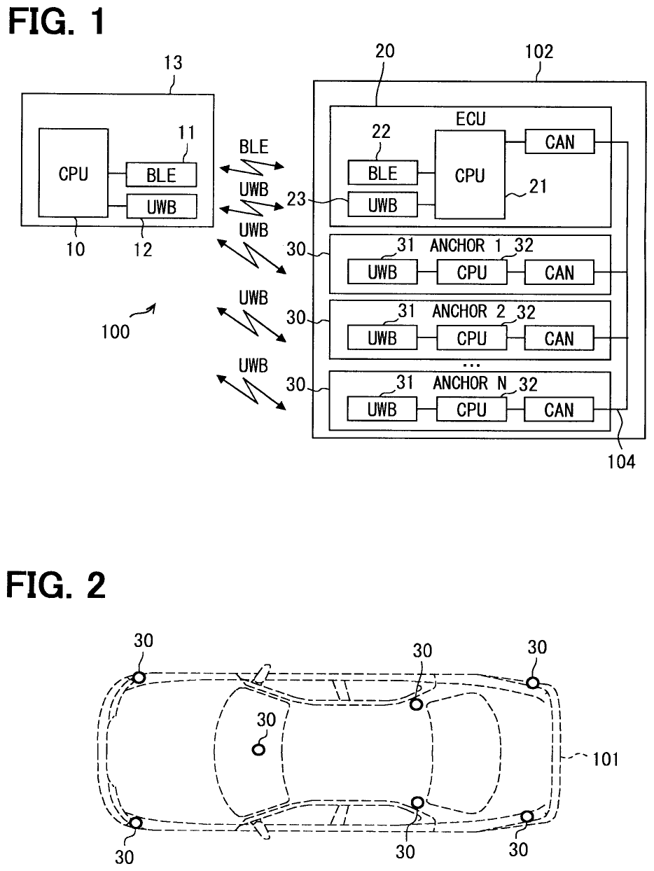

A first embodiment of the present disclosure will be described with reference to FIGS. 1 to 5. An electronic key system 100 of the first embodiment is applied to a vehicle 101. As shown in FIG. 1, the electronic key system 100 includes an in-vehicle system 102 and a mobile device 103. The in-vehicle system 102 is a system mounted on the vehicle 101. The mobile device 103 is a device carried by a user of the vehicle 101. Multiple mobile devices 103 may be present. The electronic key system 100 corresponds to a position estimation system, which estimates a position of the mobile device 103 relative to the vehicle 101 through wireless communication with the mobile device 103.

First, the electronic key system 100 is explained. The in-vehicle system 102 and the mobile device 103 are configured for short-range communication with each other. Here, the short-range communication refers to communication conforming to a predetermined short-range wireless communication standard in which a substantial communicable distance is, for example, about 5 meters to 100 meters. In the present embodiment, BLE (Bluetooth Low Energy, Bluetooth is a registered trademark) and UWB-IR (Ultra Wide Band-Impulse Radio), for example, are used as short-range communication standards.

The in-vehicle system 102 and the mobile device 103 are each configured to implement wireless communication in accordance with the BLE standard. Therefore, details of a communication method related to communication connection and encrypted communication are performed by a sequence defined by the BLE standard.

Hereinafter, a case where the in-vehicle system 102 is set to act as a master in communication with the mobile device 103 and the mobile device 103 is set to act as a slave will be described. The slave in BLE communication is a device that intermittently transmits an advertisement signal, and transmits and receives data based on a request from the master. The master is a device that controls a communication connection state and communication timing with the slave.

An advertise signal is a signal to notify other devices of its own presence. Signals transmitted and received by BLE, such as advertisement signals, contain source information. The source information is, for example, a unique identification assigned to the mobile device 103. As device identification information, for example, a device address, a UUID (Universally Unique Identifier), or the like can be adopted.

The mobile device 103 is a device that holds key information for use of the vehicle 101 and functions as an electronic key for the vehicle 101 using the key information. The key information is data used in an authentication process described later. The key information is data for certifying that a person who attempts to access the vehicle 101 is an authorized user, that is, validity of the person who attempts to access the vehicle 101. The key information can be called an authentication key, an encryption key, or a key code. The key information can be different for each mobile device 103. The key information for each mobile device 103 is stored and registered in the in-vehicle system 102, associated with the device identification information.

The in-vehicle system 102 performs an automatic authentication process with the mobile device 103 through wireless communication. The in-vehicle system 102 then implements vehicle control based on a user's position relative to the vehicle 101, provided that the authentication is successful. The vehicle control here includes locking/unlocking doors of the vehicle, turning on/off the power of the vehicle, starting the engine, and the like.

For example, when the in-vehicle system 102 is able to confirm that the mobile device 103 is within a predetermined locking-unlocking area for the vehicle 101, the in-vehicle system 102 performs controls such as locking or unlocking the doors based on user operation of door buttons. The locking-unlocking area is set outside a vehicle compartment, near a driver's door, near an assistant driver's door, and near a trunk door.

Further, the in-vehicle system 102 executes a start control of the engine based on the user operation on a start button when it has been confirmed that the mobile device 103 exists in the vehicle compartment by the wireless communication with the mobile device 103.

The authentication of the mobile device 103 by the in-vehicle system 102 can be performed, for example, by a challenge-response method. The authentication process is a matching process between a response code generated by the mobile device 103 based on the key information and a verification code maintained or dynamically generated by the vehicle 101.

Next, process of the mobile device 103 will be described. The mobile device 103 is a portable and general-purpose information processing terminal having a communication function. A digital key application, which is an application to function as the electronic key for the vehicle 101, is installed on the mobile device 103. As the mobile device 103, for example, a smartphone, a tablet terminal, a wearable device, or the like can be adopted. The wearable device is a device that is worn and used on the user's body, and can be of various shapes such as a wristband type, a wristwatch type, a ring type, a glasses type, and an earphone type.

The mobile device 103 has a terminal controller 10, a portable BLE module 11, and a portable UWB module 12, as shown in FIG. 1. In the present embodiment, for convenience, the description of the mobile device 103, other than a configuration related to the wireless communication with the in-vehicle system 102, is omitted.

The portable BLE module 11 is a communication module capable of the short-range wireless communication in accordance with the BLE standard. The portable BLE module 11 includes, for example, an IC, antenna, and communication circuitry. The portable BLE module 11 establishes a communication connection with the in-vehicle system 102 to perform the short-range wireless communication.

The portable BLE module 11 scans and receives periodic advertisement signals sent periodically from the in-vehicle system 102. Upon receiving the advertising signal, the portable BLE module 11 sends a connection request to the in-vehicle system 102. When this connection request is accepted, the communication connection is established between the portable BLE module 11 and the in-vehicle system 102.

The portable UWB module 12 is a communication module capable of the short-range wireless communication in UWB-IR format. Hereafter, UWB-IR short-range wireless communication is referred to as UWB communication. The UWB communication can also be described as ultra-wideband wireless communication. The portable UWB module 12, like the portable BLE module 11, includes, for example, an IC, antenna, and communication circuits.

The portable UWB module 12 perform the UWB communication by transmitting and receiving impulse-like radio waves (hereinafter “impulse signals”). An impulse signal used in the UWB communication is a signal having an extremely short pulse width. For example, the impulse signal has a pulse width of 2 ns. The impulse signals used in the UWB communication are signals with a bandwidth of 500 MHz or more (i.e., ultra-wide bandwidth). Frequency bands that can be used in the UWB communication (hereinafter, a UWB band) include 3.1 GHz to 10.6 GHz, 3.4 GHz to 4.8 GHZ, 7.25 GHz to 10.6 GHZ, 22 GHz to 29 GHz, and the like. When the portable UWB module 12 receives the impulse signal transmitted from the in-vehicle system 102, the portable UWB module 12 sends back a response signal corresponding to the impulse signal.

The terminal controller 10 is realized by a central processing device (i.e., CPU) and controls the portable BLE module 11 and the portable UWB module 12. The terminal controller 10 executes processes to realize functions of the various parts of the mobile device 103. The terminal controller 10 executes a program stored in memory to enable communication with the in-vehicle system 102.

Next, the in-vehicle system 102 will be described. The in-vehicle system 102 includes a smart ECU 20 and anchors 30, as shown in FIG. 1. The ECU is an abbreviation of Electronic Control Unit. The anchors 30 correspond to a communicator.

The smart ECU 20 is connected to each of the anchors 30 by an in-vehicle network 104. The smart ECU 20 is connected to other in-vehicle control units, such as a power supply ECU and a body ECU, for intercommunication via the in-vehicle network 104. The in-vehicle network 104 is a communication network constructed in the vehicle 100. A standard for the in-vehicle network 104 is, for example, the Controller Area Network (CAN: registered trademark).

The smart ECU 20, in cooperation with the anchors 30 and others, estimates the position of the mobile device 103. The smart ECU 20 realizes vehicle control according to the estimation result of the position of the mobile device 103 in cooperation with other ECUs. The smart ECU 20 is realized by using a computer. That is, the smart ECU 20 includes a processor 21, a random access memory (i.e., RAM), a storage, an input-output module, and a bus line connecting these components. In FIG. 1, only processor 21 of these is illustrated.

The processor 21 is hardware (in other words, an arithmetic core) for arithmetic processing coordinated with the RAM. The processor 21 is, for example, a CPU. The processor 21 accesses the RAM to execute various processes for realizing the functions of the respective functional units. The RAM is a volatile storage medium. The storage includes a nonvolatile storage medium such as a flash memory. The storage stores various programs executed by the processor 21. An execution of the programs by the processor 21 corresponds to an execution of a method corresponding to the programs, e.g., the position estimation method. The input-output module is a circuit module for communicating with another device. The input-output module is realized by using an analog circuit element, an IC, or the like.

In the storage 43, the device identification information of each mobile device 103 is registered. The storage also contains setting data indicating an installation position of each anchor 30 in the vehicle 101. The storage corresponds to a storage device in which the setting data is stored.

The smart ECU 20 includes a vehicular BLE module 22 and a vehicular UWB module 23. The vehicular BLE module 22 is a communication module capable of the short-range wireless communication in accordance with the BLE standard. The vehicular BLE module 22 has the same configuration as the portable BLE module 11 described above. The vehicular BLE module 22 establishes a communication connection with the mobile device 103 to perform the short-range wireless communication.

The vehicular UWB module 23 is a communication module capable of the UWB communication. The vehicular UWB module 23 has the same configuration as the portable UWB module 12 described above. The vehicular UWB module 23 performs the UWB communication by transmitting and receiving impulse signals. When the vehicular UWB module 23 receives the impulse signal transmitted from the mobile device 103, the vehicular UWB module 23 sends back a response signal corresponding to the impulse signal.

The anchors 30 are configured to communicate wirelessly with the mobile device 103 and are located at different positions in the vehicle 101. An anchor 30 is one of the anchors 30, and the anchor 30 is a communication module that includes an anchor UWB module 31 and an anchor controller 32. The anchor 30 performs the UWB communication in accordance with the instructions of the smart ECU 20. The anchor 30 corresponds to an antenna. The anchors 30 are provided at multiple positions inside and outside the vehicle compartment of the vehicle 101. Two or more anchors 30 are provided in the vehicle 101, including the anchor 30 located inside the vehicle compartment the anchor 30 located outside the vehicle compartment. Each anchor 30 is assigned a unique identifier.

An example of placement of the anchors 30 of the present embodiment will be explained using FIG. 2. As shown in FIG. 2, a total of seven anchors 30 are located, four outside the vehicle compartment and three inside the vehicle compartment. In FIG. 1, only three anchors 30 are shown for ease of understanding. The multiple anchor 30 are equal to each other.

The four anchors 30 outside the vehicle compartment are located near left and right corners of a front end of the vehicle 101 and at the left and right corners of a rear end, respectively. The three anchors 30 in the vehicle compartment are located one in an instrument panel at a front center of the vehicle compartment and one on each side of rear seats.

The anchor controller 32 uses impulse signal transmission and reception to obtain time-of-flight related values. The time-of-flight related values are also referred to as ToF related values. The ToF related value is a parameter that directly or indirectly indicates the time of flight of radio waves from the anchor 30 to the mobile device 103. A distance from the anchor 30 to the mobile device 103 corresponds to Time of Flight (ToF) of signals.

ToF is determined based on a two-frequency phase difference and a round-trip time (RTT: Round-Trip Time). The two-frequency phase difference and RTT correspond to the ToF related values. The ToF related values can also be called distance-related values. The ToF related value is a parameter different from the reception strength. The two-frequency phase difference is a difference between transmit and receive phase differences observed at two different frequencies from each other. The two-frequency phase difference corresponds to a displacement amount of a transmission and reception phase angle due to a change in frequency. The transmit receive phase difference corresponds to a phase difference between a transmitted CW signals and a received CW signals. The transmit receive phase difference is also simply referred to as a phase angle.

In the present embodiment, the round trip time is used as the ToF related value. More specifically, the anchor controller 32 measures the round trip time, which is a time elapsed from transmission of an impulse signal to reception of an impulse signal as a response signal to the impulse signal. The anchor controller 32 outputs the measured round trip time to the smart ECU 20 along with its own identification information. A method of obtaining round trip time described here is only an example. Other methods may be used as long as the round trip time used for ranging between the anchor 30 and the mobile device 103 can be obtained.

Furthermore, the anchor controller 32 measures the signal strength received by the anchor UWB module 31. The anchor controller 32 is configured to successively detect the signal strength received by the anchor UWB module 31. A signal indicating the reception strength or a measurement value thereof may be referred to as a received signal strength indicator/indication (i.e., RSSI). The anchor controller 32 outputs the measured reception strength to the smart ECU 20 along with its own identification information.

Next, control of the smart ECU 20 will be described. The smart ECU 20 causes the vehicular BLE module 22 to transmit an advertising signal. The smart ECU 20 causes the vehicular BLE module 22 to periodically transmit the advertising signal after a certain period of time has elapsed from a time when the vehicle 101 is parked and then all the doors of the vehicle 101 are locked.

The smart ECU 20 obtains information about the wireless communication with the mobile device 103 from the vehicular BLE module 22. The smart ECU 20 acquires information received by the vehicular BLE module 22 when a connection is established between the portable BLE module 11 and the vehicular BLE module 22 of the mobile device 103 that received the advertising signal.

The smart ECU 20 also functions as a communication controller and controls operations of the anchors 30. The smart ECU 20 causes the impulse signal to be transmitted from the vehicular UWB module 23. Similarly, the smart ECU 20 causes the anchor UWB module 31 of each anchor 30 to transmit the impulse signal.

The smart ECU 20 causes the anchors 30 to send impulse signals in turn. The smart ECU 20, for example, causes each of the anchors 30 to transmit the impulse signal in turn after a predetermined time interval.

The smart ECU 20 is triggered to start sending the impulse signals when the connection with the portable BLE module 11 of the mobile device 103 is established or has been established. This prevents the smart ECU 20 from causing the anchors 30 to send the impulse signal even though there is no mobile device 103 in a vicinity of the vehicle 101.

The smart ECU 20 acquires information about UWB communication, which is received by the anchor 30 when the UWB communication is performed between the UWB module of the mobile device 103 and the anchor 30. The smart ECU 20 obtains the round trip time output from each of the anchors 30 as the ToF related value. Therefore, the smart ECU 20 obtains the ToF related values from each of the anchors 30. The smart ECU 20 also obtains the reception strength from each of the anchors 30. Thus, the smart ECU 20 obtains the reception strength of the signal from the mobile device 103 at each of the anchors 30.

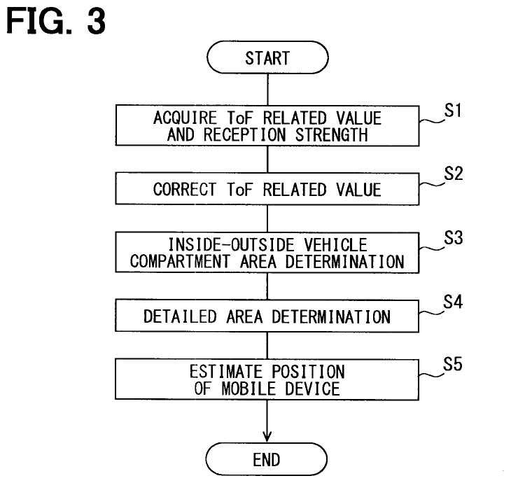

Next, the position estimation method of the mobile device 103 will be described. Processes shown in FIG. 3 are repeated by the smart ECU 20 over a short period of time. The smart ECU 20 also functions as a position estimation unit, estimating the position where the mobile device 103 is located.

In step S1, the ToF related values and the reception strength are acquired from each of the anchors 30, and the process proceeds to step S2. In step S2, the ToF related values are corrected using a correction function, and the process proceeds to step S3. The correction function outputs the corrected ToF related values by inputting the reception strength and the ToF related values obtained in step S1.

In step S3, the smart ECU 20 determines whether the mobile device 103 is inside or outside the vehicle compartment, and proceeds to step S4. To determine whether the vehicle is inside the vehicle compartment, the corrected ToF related value may be used, or only the reception strength may be used, or the uncorrected ToF related value and the reception strength may be used.

In step S4, detailed area determination is performed inside or outside the vehicle compartment as determined in step S3, and the process proceeds to step S5. The detailed area determination is a process of dividing the vehicle compartment or outside of the vehicle into smaller areas and determining in which of the divided areas the mobile device 103 is located. The area here may be an area with an area, or it may be a process that specifies any one of several discrete points.

In step S5, the corrected ToF related values are used to estimate the position of the mobile device 103, and the process terminates. In step S5, a calculation process is performed to find a position with better accuracy using one specific point in the area determined in step S4 as a tentative position. One specific point in the area may be any point, it may be the center of gravity of the area, or it may be any vertex of the area. In step S5, for example, positioning is performed using a nonlinear least-squares method. Since the nonlinear least-squares method iteratively calculates from an initial position to find a minimum error point, the initial position is an important factor, and if the initial position is wrong, convergence to a local solution will result in erroneous determination.

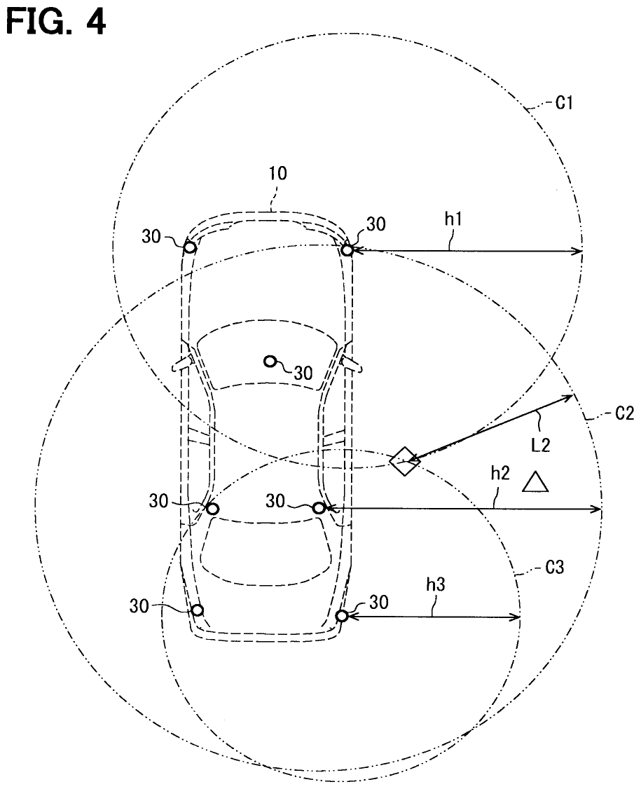

Therefore, in step S4, the detailed area determination is performed. The position estimation in steps S4 and S5 is explained using FIG. 4. In FIG. 4, for ease of understanding, distance measuring circles C1 to C3 of the three anchors 30 on the right side of the seven anchors 30 are used. An actual position of the mobile device 103 is also indicated by a triangle.

The distance measuring circles C1 to C3 in FIG. 4 are circles centered at each of the anchors 30, with radii h1 to h3 as the distances identified using the corrected ToF related values in step S2. Ideally, the distance measuring circles C1 to C3 should intersect at a single point at the position of the mobile device 103. However, as shown in FIG. 4, there may be no point where the three distance measuring circles C1 to C3 intersect at a single point. This is due to various measurement errors.

In step S5, the initial position must be set to estimate the position of the mobile device 103 using the nonlinear least squares method. Therefore, in step S4, there is no point where the three distance measuring circles C1 to C3 intersect at a single point, but a tentative position where the mobile device 103 is likely to be located is set and the initial position is set to the tentative position. The tentative position is a point in the detailed area set in step S4.

In an example shown in FIG. 4, there are six intersections of the three distance measuring circles C1 to C3. Of these, the intersection closest to the actual position of the mobile device 103, that is, a triangle in FIG. 4, may be set as the initial position. Therefore, the initial position is set by a statistical model learned using teaching data, as described below. In the example shown in FIG. 4, the initial position is a point where the two distance measuring circles C1, C3 intersect, as shown by a diamond shape. Then, in step S5, starting from this initial position, a position where the sum of distances from each distance measuring circles C1 to C3 is the smallest is mathematically searched. In the initial position shown in FIG. 4, a distance to the two distance measuring circles C1, C3 is 0. A distance to the distance measuring circle C2 is indicated by an arrow L2.

Next, the correction function used in step S2 will be described. The correction function is a function determined using teaching data that includes positions of the mobile device 103 and the reception strength and the ToF related values at positions of the mobile device 103, which is smaller in data volume than the teaching data. The teaching data are, for example, actual measured data of ToF values and reception strength at 16530 measurement points inside and outside the vehicle compartment.

In the present embodiment, machine learning, which can handle large amounts of data, is used to perform highly accurate correction. The ToF related values and reception strength of each anchor 30 and the mobile device 103 are learned by acquiring data in the vicinity of the vehicle 101 in advance. When learning that covers the position around the vehicle 101, a large amount of data is handled, but logic must be executed in the smart ECU 20 that has a small capacity, such as an ECU in the vehicle 101, so a neural network that can efficiently learn and reduce the ROM capacity of the smart ECU 20 is used in a method.

The neural network is capable of reducing an amount of data used more than pattern matching. Assume, for example, that each ToF related value and reception strength is obtained as teaching data at 16530 measurement points inside and outside the vehicle compartment. In this case, the ToF related values and reception strength due to the seven anchors 30 are obtained at one measurement position. Therefore, with seven antennas with two parameters and 16530 measurement points, a data volume of 231420 data points is required. This makes the amount of data for the teaching data approximately 1850 KB.

When pattern matching is used to correct the measurements obtained at each anchor 30, a larger amount of data is preferable, so the teaching data is used as is, and corrections are made by interpolation and extrapolation. Then the smart ECU 20 needs to store the teaching data.

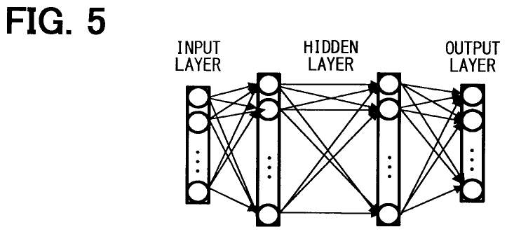

Contrary to this, consider a case of a multilayer perceptron neural network, as shown in FIG. 5. If the neural network has, for example, an input layer, two hidden layers, and an output layer, the input and output layers need seven nodes, corresponding to seven anchors 30. Then set up 50 nodes in each of the two hidden layers. In this case, thresholds, gains and weightings for each layer are the numbers shown in Table 1. The number of gains and weightings can also be the number of paths from each layer to the next.

TABLE 1

| | INPUT | HIDDEN | HIDDEN | OUTPUT |
|---|---|---|---|---|
| | LAYER | LAYER | LAYER | LAYER |
| THRESHOLD | 7 | 50 | 50 | 7 |
| GAIN AND | 7 | 350 | 2500 | 350 |
| WEIGHTING | | | | |

Therefore, the neural network requires 3321 data volume for the total number of thresholds, gains, and weightings. This amount of data is approximately 26.5 KB. Therefore, it is approximately 1/70 of the teaching data. The neural network performs a predetermined operation on the input value and outputs the value. Thus, the neural network can be said to be a correction function.

Next, other determination methods in step S3 of FIG. 3 will be described. When determining whether the vehicle is inside the vehicle compartment in step S3, a statistical model may be used to make the determination. The statistical model outputs whether the mobile device 103 is inside or outside the vehicle compartment by inputting the reception strength and ToF related values obtained in step S1. This statistical model is pre-trained to determine whether the mobile device is inside the vehicle compartment, using the same teaching data as described above. The learning may be performed using machine learning. As machine learning, deep learning may be used.

Next, another determination method in step S4 of FIG. 3 will be described. The detailed area determination in step S4 may be determined using other statistical models instead of using the corrected ToF related values. A statistical model may then use a different statistical model for the inside of the vehicle compartment and for the outside of the vehicle compartment.

A statistical model for the vehicle compartment identifies an area where the mobile device 103 is present by inputting the reception strength and ToF related values obtained in step S1, using a statistical model that outputs in which of the multiple predefined areas in the vehicle compartment the mobile device 103 is present. A statistical model for outside of the vehicle identifies an area where the mobile device 103 is present by inputting the acquired reception strength and ToF related values, using a statistical model that outputs which of the multiple predefined areas outside of the vehicle is the area where the mobile device 103 is present.

This statistical model is trained using the teaching data for the vehicle compartment, and a statistical model for the outside of the vehicle is trained using the teaching data for the outside of the vehicle. Since the trends of reception strength and ToF related values are different between inside and outside the vehicle compartment, an area can be identified more accurately.

As described above, in accordance with the position estimation system and the position determination method of the present embodiment, the reception strength and the ToF related values at each of the multiple anchors 30 are used to estimate the position of the mobile device 103. The reception strength and the ToF related values are different parameters from each other and may have different factors that cause errors. Therefore, an estimated position of the mobile device 103 using only the reception strength may not match an estimated position of the mobile device 103 using only the ToF related values. Therefore, the ToF related values are corrected using the correction function that outputs the corrected ToF related values by inputting the acquired reception strength and the ToF related values.

The correction function is a function determined using the teaching data that includes positions of the multiple mobile devices 103 and the reception strength and the ToF related values at the positions of the multiple mobile devices 103. The correction function is then generated so that the amount of data is smaller than the teaching data. As a result, an amount of data can be reduced compared to storing all of the teaching data and correcting using the teaching data. Since the correction is performed by the correction function using two parameters, correction accuracy can be improved compared to a configuration in which only one parameter is used for correction. As a result, the position of the mobile device 103 can be more accurately estimated using the corrected time-of-flight related values.

As explained in step S5 of FIG. 3, in the present embodiment, this method sets the tentative position of the mobile device 103 set using the corrected ToF related values as the initial value for the nonlinear least-squares method, searches from the initial value, and estimates a position where a distance from the corrected time-of-flight related values is the smallest as the position of the mobile device 103. By using the corrected ToF related values, the initial values can be set accurately, thus improving the accuracy of position estimation.

Thus, in the present embodiment, the position estimation system and the position determination method use not only the ToF related value of each of the 30 anchors, but also radio wave strength information as a parameter for estimating the position of the mobile device 103. The ToF related values are then corrected using the actual data measured in advance with multiple anchors 30. Machine learning is used for correction, but a method uses the neural network that can learn efficiently to make the capacity implementable in a microcontroller installed in the vehicle 101. The application of the neural networks can be reduced to a capacity that can be installed in the smart ECU 20.

In order to prevent key binding inside the vehicle and to secure an engine start area, the system first determines whether the vehicle is inside or outside the vehicle compartment, and then determines the detailed area and estimates the position of the key. By using the neural network, area determination inside and outside of the vehicle can be made with a high degree of accuracy. The combination of the neural network to select the best initial position can also improve the positioning accuracy by the nonlinear least squares method.

### Other Embodiments

The present disclosure is not limited to the preferred embodiments of the present disclosure described above. Various modifications may be made without departing from the subject matters of the present disclosure.

It should be understood that the configurations described in the above-described embodiments are example configurations, and the present disclosure is not limited to the foregoing descriptions. The scope of the present disclosure encompasses claims and various modifications of claims within equivalents thereof.

In the first embodiment, the detailed area determination is performed in step S4 after determining the inside and outside of the vehicle compartment in step S3 of FIG. 3, but this configuration is not limited to determining detailed areas in two steps. For example, a statistical model identify an area where the mobile device 103 is present by inputting the acquired reception strength and ToF related values, using a statistical model that outputs which of the multiple predefined areas outside and inside of the vehicle 101 is the area where the mobile device 103 is present. The statistical model, like any other statistical model, can be obtained by learning from teaching data. As a result, processes in steps S3 and S4 in FIG. 3 can be combined into a single process.

In the first embodiment, one point in the area determined by the detailed area determination is set as the initial value in step S4 of FIG. 3, but this configuration is not limited to this. For example, distance measuring circles may be generated from the corrected ToF related values and a point equidistant from intersections of multiple distance measuring circles may be set as a tentative position, or a center point of an area where the intersections of multiple distance measuring circles are gathered may be set as a tentative position.

In the first embodiment, the round trip time is used as the ToF related value, but it is not limited to this configuration. As a ToF related value, for example, a two-frequency phase difference for each frequency combination may be employed. In the BLE communication, there are more than two frequencies provided for communication, so two or more two-frequency phase differences with different frequency combinations are obtained. A device distance is estimated based on this two-frequency phase difference.

In a configuration that uses multi-frequency phase differences as ToF related values, communications for ranging can be interpreted as communications for identifying the phase difference between transmission and reception for each of two or more frequencies. Sending and receiving CW signals on multiple frequencies can fall under communications for ranging.

In the first embodiment, the position of the mobile device 103 is estimated using the reception strength and the ToF related values, but other position estimation methods may be combined. For example, the smart ECU 20 may obtain a direction of arrival of a signal as information indicating a reception status of the signal from the mobile device 103. The direction of arrival of the signal can be estimated by various methods such as the MUSIC method or the ESPRIT method. The reception strength, phase, and direction of arrival can be called received signal characteristics.

In the first embodiment, the functions realized by the smart ECU 20 may be realized by hardware and software different from those described above or by a combination of the hardware and the software. The smart ECU 20 may communicate with, for example, another control device, and the other control device may execute a part or all of the process. When the smart ECU 20 is realized by an electronic circuit, the smart ECU 20 may be realized by a digital circuit or an analog circuit, including a large number of logic circuits.

A configuration in which a certain function is implemented by hardware includes a configuration in which the function is implemented by use of one or more ICs or the like. As the processor (arithmetic core), a CPU, an MPU, a GPU, a DFP (Data Flow Processor), or the like can be adopted. Some or all of the functions of the processor may be implemented by combining multiple types of arithmetic processing devices. Some or all of the functions of the processor may be implemented using a system-on chip (SoC), an FPGA, an ASIC, or the like. The FPGA is an abbreviation for Field Programmable Gate Array. The ASIC is an abbreviation for Application Specific Integrated Circuit.

Further, the computer program to be executed by a control device may be stored in a computer-readable non-transitionary tangible storage medium as an instruction executed by the computer. As a program storage medium, an HDD (Hard-disk Drive), an SSD (Solid State Drive), a flash memory, or the like can be adopted.

Whereas the position estimation device is used in the vehicle 101 in the above-described first embodiment, the position estimation device is not limited to a state being mounted on the vehicle 101, and at least a part of the position estimation device may not be mounted on the vehicle 101.

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

What is claimed is:

1. A position estimation system configured to estimate a position of a mobile device relative to a vehicle by wirelessly communicating with the mobile device carried by a user, the position estimation system comprising:
communicators configured to wirelessly communicate with the mobile device and installed at different positions in the vehicle;
a communication controller configured to control operation of the communicators; and
a position estimation unit configured to estimate a position of the mobile device, wherein
the communication controller is configured to:
acquire reception strength of signals of the mobile device at the communicators, respectively; and
acquire a time-of-flight related value, which is a parameter different from the reception strength, that directly or indirectly indicates a time of flight of radio waves sent from the communicators to the mobile device,
the position estimation unit is configured to:
correct the time-of-flight related value using a correction function that is for acquiring a corrected time-of-flight related value by inputting the reception strength and the time-of-flight related value acquired by the communication controller; and
estimate the position of the mobile device using the corrected time-of-flight related value,
the correction function is a function determined using teaching data including positions of the mobile device and the reception strength and the time-of-flight related values at the positions of the mobile device, and
a data volume of the correction function is smaller than a data volume of the teaching data.

2. The position estimation system according to claim 1, wherein
the position estimation unit is configured to:
set a tentative position of the mobile device using the corrected time-of-flight related value;
set the tentative position to an initial value for a nonlinear least squares method;
start a search from the initial value and search for a position having a minimum distance from a position determined by the corrected time-of-flight related value; and
estimate the position having the minimum distance as a position of the mobile device.

3. The position estimation system according to claim 1, wherein
the position estimation unit is configured to:
identify an area in which the mobile device is present using a statistical model that is for acquiring which of predefined areas inside and outside the vehicle where the mobile device is present by inputting the reception strength and the time-of-flight related value acquired by the communication controller;
set a point in the identified area to an initial value for a nonlinear least squares method;
start a search from the initial value and search for a position having a minimum distance from a position determined by the corrected time-of-flight related value; and
estimate the position having the minimum distance as a position of the mobile device.

4. The position estimation system according to claim 1, wherein
the position estimation unit is configured to:
determine whether the mobile device is in a vehicle compartment of the vehicle using at least one of the reception strength and the time-of-flight related value acquired by the communication controller;
identify an area in the vehicle compartment in which the mobile device is present using a statistical model that is for acquiring which of predefined areas in the vehicle compartment where the mobile device is present by inputting the reception strength and the time-of-flight related value acquired by the communication controller in response to a determination that the mobile device is in the vehicle compartment;
identify an area outside the vehicle compartment in which the mobile device is present using a statistical model that is for acquiring which of predefined areas outside the vehicle compartment where the mobile device is present by inputting the reception strength and the time-of-flight related value acquired by the communication controller in response to a determination that the mobile device is outside the vehicle compartment;
set a point in the identified area to an initial value for a nonlinear least squares method;
start a search from the initial value and search for a position having a minimum distance from a position determined by the corrected time-of-flight related value; and
estimate the position having the minimum distance as a position of the mobile device.

5. A position estimation method performed by at least one processor for estimating a position of a mobile device carried by a user, the position estimation method comprising:
acquiring reception strength of signals of the mobile device at communicators configured to wirelessly communicate with the mobile device and installed at different positions in a vehicle, respectively;
acquiring a time-of-flight related value, which is a parameter different from the reception strength, that directly or indirectly indicates a time of flight of radio waves sent from the communicators to the mobile device;
correct the time-of-flight related value using a correction function that is for acquiring a corrected time-of-flight related value by inputting the reception strength and the time-of-flight related value acquired in the acquiring; and
estimate the position of the mobile device using the corrected time-of-flight related value, wherein
the correction function is a function determined using teaching data including positions of the mobile device and the reception strength and the time-of-flight related values at the positions of the mobile device, and
a data volume of the correction function is smaller than a data volume of the teaching data.

6. A position estimation system configured to estimate a position of a mobile device relative to a vehicle by wirelessly communicating with the mobile device carried by a user, the position estimation system comprising:
communicators configured to wirelessly communicate with the mobile device and installed at different positions in the vehicle;
at least one processor; and
at least one memory storing computer program code, wherein
the at least one memory and the computer program code are configured, with the at least one processor, to cause the position estimation system to carry out:
controlling operation of the communicators;
estimating a position of the mobile device;
acquiring reception strength of signals of the mobile device at the communicators, respectively;
acquiring a time-of-flight related value, which is a parameter different from the reception strength, that directly or indirectly indicates a time of flight of radio waves sent from the communicators to the mobile device;
correcting the time-of-flight related value using a correction function that is for acquiring a corrected time-of-flight related value by inputting the reception strength and the time-of-flight related value acquired by the communication controller; and
estimating the position of the mobile device using the corrected time-of-flight related value,
the correction function is a function determined using teaching data including positions of the mobile device and the reception strength and the time-of-flight related values at the positions of the mobile device, and
a data volume of the correction function is smaller than a data volume of the teaching data.
